(19) United States
(12) Patent Application Publication
(10) Pub. No.: US 2022/0391248 A1
(43) Pub. Date: Dec. 8, 2022

(54) Monitoring Apparatus, Device, Method, and Computer Program and Corresponding System

(71) Applicants: Prashant CHAUDHARI, Folsom, CA (US); Stanislav BRATANOV, Portland, OR (US); Peinan ZHANG, San Jose, CA (US); Jeffery S. BOLES, Folsom, CA (US)

(72) Inventors: Prashant CHAUDHARI, Folsom, CA (US); Stanislav BRATANOV, Portland, OR (US); Peinan ZHANG, San Jose, CA (US); Jeffery S. BOLES, Folsom, CA (US)

(21) Appl. No.: 17/819,325

(22) Filed: Aug. 12, 2022

(51) Int. Cl. G06F 9/48; G06F 9/38; G06F 9/54

(52) U.S. Cl. CPC G06F 9/4881; G06F 9/3836; G06F 9/542

(57) ABSTRACT

Examples relate to a monitoring apparatus, a monitoring device, a monitoring method, and to a corresponding computer program and system. The monitoring apparatus is configured to obtain a first compute kernel to be monitored and to obtain one or more second compute kernels. The monitoring apparatus is configured to provide instructions, using interface circuitry, to control circuitry of a computing device comprising a plurality of execution units, to instruct the control circuitry to execute the first compute kernel using a first slice of the plurality of execution units and to execute the one or more second compute kernels concurrently with the first compute kernel using one or more second slices of the plurality of execution units, and to instruct the control circuitry to provide information on a change of a status of at least one hardware counter associated with the first slice that is caused by the execution of the first compute kernel. The monitoring apparatus is configured to determine information on the execution of the first compute kernel based on the information on the change of the status of the at least one hardware counter.

### FIELD

Examples relate to a monitoring apparatus, a monitoring device, a monitoring method, and to a corresponding computer program and system.

### BACKGROUND

Modern Graphics Processing Units (GPUs) are often used to execute multiple tasks (known in the industry as compute kernels) and multiple threads concurrently. This concurrency makes precisely measuring the performance and microarchitectural characteristics (e.g., access to various GPU resources, stalls, etc.) of each individual kernel, without adversely affecting execution of neighboring kernels and threads, difficult. For example, API (Application Programming Interface) tracing and binary instrumentation can be used to determine such performance and microarchitectural characteristics. However, they cause serialization of thread and kernel execution or are limited to only one hardware thread per execution unit, in order to produce any meaningful and accurate data. These limitations and consequences change the hardware behavior, as well as software behavior, fundamentally and can thus defeat the purpose of performance monitoring by measuring performance characteristics in a totally different, non-concurrent environment. Stall sampling is another approach that enables collection of certain statistics for a kernel. However, statistical methods, like stall sampling, have limited precision and, by definition, do not provide for exact measurements of any execution characteristic of a kernel. Besides, their precision is usually in direct correlation with their overhead.

### BRIEF DESCRIPTION OF THE FIGURES

Some examples of apparatuses and/or methods will be described in the following by way of example only, and with reference to the accompanying figures, in which

FIG. 1a shows a block diagram of an example of a monitoring apparatus or monitoring device;

FIG. 1b shows a block diagram of an example of a system comprising a monitoring apparatus or monitoring device and a computing device;

FIG. 1c shows a flow chart of an example of a monitoring method;

FIG. 2a shows a block diagram of an example of a computing device and of a system comprising the computing device and a monitoring apparatus or monitoring device;

FIG. 2b shows a flow chart of an example of a method;

FIG. 3 shows a schematic diagram of an example of an overall GPU architecture of a GPU;

FIG. 4 shows a flow chart of an example of a kernel profiling approach without using the proposed concept; and

FIG. 5 shows a flow chart of an example of the proposed concept.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details a reset forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

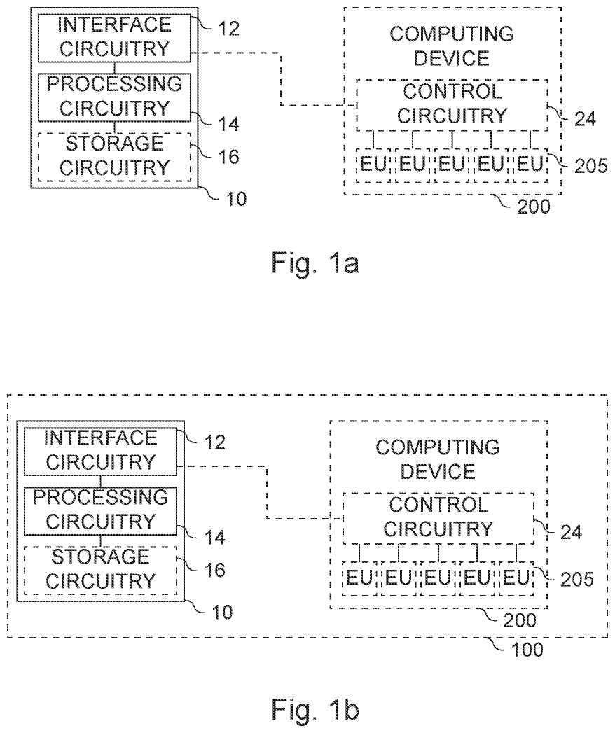

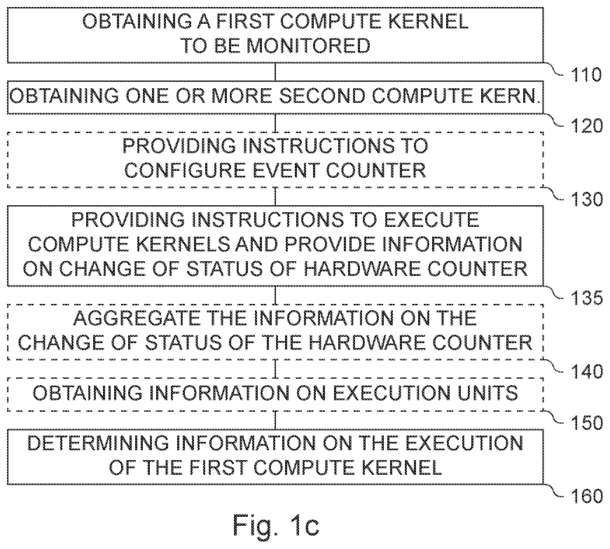

FIG. 1a shows a block diagram of an example of a monitoring apparatus 10 or monitoring device 10. The apparatus 10 comprises circuitry that is configured to provide the functionality of the apparatus 10. For example, the monitoring apparatus 10 of FIGS. 1a and 1b comprises interface circuitry 12, processing circuitry 14 and (optional) storage circuitry 16. For example, the processing circuitry 14 may be coupled with the interface circuitry 12 and with the storage circuitry 16. For example, the processing circuitry 14 may be configured to provide the functionality of the monitoring apparatus, in conjunction with the interface circuitry 12 (for exchanging information, e.g., with other components inside or outside a computer system 100 comprising the monitoring apparatus or monitoring device 10, such as a computing device 200) and the storage circuitry (for storing information, such as machine-readable instructions) 16. Likewise, the monitoring device 10 may comprise means that is/are configured to provide the functionality of the monitoring device 10. The components of the monitoring device 10 are defined as component means, which may correspond to, or implemented by, the respective structural components of the monitoring apparatus 10. For example, the monitoring device 10 of FIGS. 1a and 1b comprises means for processing 14, which may correspond to or be implemented by the processing circuitry 14, means for communicating 12, which may correspond to or be implemented by the interface circuitry 12, and (optional) means for storing information 16, which may correspond to or be implemented by the storage circuitry 16. In general, the functionality of the processing circuitry 14 or means for processing 14 may be implemented by the processing circuitry 14 or means for processing 14 executing machine-readable instructions. Accordingly, any feature ascribed to the processing circuitry 14 or means for processing 14 may be defined by one or more instructions of a plurality of machine-readable instructions. The monitoring apparatus 10 or monitoring device 10 may comprise the machine-readable instructions, e.g., within the storage circuitry 16 or means for storing information 16.

The processing circuitry 14 or means for processing 14 is configured to obtain a first compute kernel to be monitored. The processing circuitry 14 or means for processing 14 is configured to obtain one or more second compute kernels (not being monitored). The processing circuitry 14 or means for processing 14 is configured to provide instructions, using the interface circuitry 12, to control circuitry 24 of the computing device 200, with the computing device 200 comprising a plurality of execution units 205 (EUs), to instruct the control circuitry to: a) execute the first compute kernel using a first slice of the plurality of execution units, b) execute the one or more second compute kernels concurrently with the first compute kernel using one or more second slices of the plurality of execution units, and c) instruct the control circuitry to provide information on a change of a status of at least one hardware counter associated with the first slice that is caused by the execution of the first compute kernel. The processing circuitry 14 or means for processing 14 is configured to determine information on the execution of the first compute kernel based on the information on the change of the status of the at least one hardware counter.

As outlined above, the monitoring apparatus 10 or monitoring device 10 may be part of a system (e.g., a computer system) comprising both the monitoring apparatus or device 10 and the computing device 200. FIG. 1b shows a block diagram of an example of a system 100 comprising the monitoring apparatus or monitoring device 10 and the computing device 200. In some examples, the system 100 may be a computer system 100. Alternatively, the system may comprise at least two computer systems, with a first computer system comprising the monitoring apparatus or device 10 and a second computer system comprising the computing device 200. Alternatively, both the monitoring apparatus and device 10 may be separate computer systems.

FIG. 1c shows a flow chart of an example of a corresponding monitoring method. The monitoring method comprises obtaining 110 the first compute kernel to be monitored. The monitoring method comprises obtaining 120 the one or more second compute kernels. The monitoring method comprises providing 135 the instructions, to the control circuitry of a computing device comprising the plurality of execution units, to instruct the control circuitry to a) execute the first compute kernel using a first slice of the plurality of execution units, b) execute the one or more second compute kernels concurrently with the first compute kernel using one or more second slices of the plurality of execution units, and c) instruct the control circuitry to provide information on a change of a status of at least one hardware counter associated with the first slice that is caused by the execution of the first compute kernel. The monitoring method comprises determining 160 the information on the execution of the first compute kernel based on the information on the change of the status of the at least one hardware counter. For example, the monitoring method may be performed by a computer system, e.g., by a monitoring apparatus or device of the computer system.

In the following, the functionality of the monitoring apparatus 10, the monitoring device 10, the monitoring method and of a corresponding computer program is illustrated with respect to the monitoring apparatus 10. Features introduced in connection with the monitoring apparatus 10 may likewise be included in the corresponding monitoring device 10, monitoring method and computer program.

Various examples of the present disclosure are based on the finding, that the profiling of compute kernels is a complex task, as compute kernels are often executed concurrently by a computing device. The concurrent execution has some consequences—for example, the concurrent execution of multiple kernels leads to the compute kernels influencing each other, e.g., due to data transfers taking longer as the interface to the computing device acts as a bottleneck, due to wait times for accessing shared hardware, due to thermal issues causing some amount of throttling in high-load scenarios etc. Moreover, such concurrent execution of compute kernels makes the use of global (i.e., across multiple threads of compute kernel) performance monitors or counters difficult, as such performance monitors or counters can be changed or affected by the “wrong” compute kernels as well.

In the present disclosure, the computing device is partitioned into multiple slices, with one of the slices being used for monitoring (i.e., profiling) the first compute kernel, and the other slice (or slices) being used to concurrently execute the second compute kernel(s). In effect, the execution units of the computing device are assigned to one of the slices, with a first subset of the execution units (i.e., the first slice) being used to execute the first compute kernel, and a second subset (i.e., the second slice, being non-overlapping with the first subset/slice) being used to execute the second compute kernel(s). In addition, one or more hardware counters, which are part of the respective slices or part of each execution unit, are used for the monitoring/profiling of the first compute kernel. Since the hardware counter(s) is/are part of the respective slice (e.g., directly or via the respective execution units), the hardware counter(s) being used to monitor/profile the first compute kernel are unaffected by the execution of the second compute kernel(s), thus enabling a reliable monitoring or profiling of the first compute kernel while the one or more second compute kernel(s) are being executed concurrently.

In the present disclosure, two compute kernels are distinguished—the first compute kernel, which is being monitored/profiled, and the one or more second compute kernels, which are generally not monitored, but executed concurrently, e.g., to simulate a realistic execution environment for the profiling of the first compute kernel. These compute kernels may have arbitrary functionality. For example, the first compute kernel and/or the one or more second compute kernels may be related to one or more of compute operations, render operations and media operations. While the first compute kernel is part of (e.g., spawned by) a single computer program, the one or more second compute kernels may belong to (i.e., be spawned by) the same computer program or to different computer programs. In general, a compute kernel is a computational routine (e.g., a part of a computer program) that is compiled for a computing device (such as a Graphics Processing Unit, a Digital Signal Processor (DSP), an FPGA (Field-Programmable Gate Array), and an Application-Specific Integrated Circuit (ASIC), such as an Artificial Intelligence (AI) accelerator. Accordingly, the computing device 200 may be one of a GPU, a DSP, an FPGA, and an ASIC, such as an AI accelerator. In general, the computing device 200 may comprise additional components in addition to the control circuitry and the execution units. For example, if the computing device is a GPU, it may comprise one or more of sampler circuitry, ray tracing circuitry, multiples of shaders of various types/functions (e.g., pixel shader, domain shader, task shader, mesh shader, hull shader, vertex shader, etc.), z pipe circuitry, geometry pipeline circuitry etc.

For example, the computing device might not be a Central Processing Unit. In general, such compute kernels are used to offload tasks of the computer program from the CPU of the computer system to another computing device. For example, the first compute kernel and the one or more second compute kernels may be obtained by reading them from storage circuitry, e.g., the storage circuitry 16 of the monitoring apparatus 10.

The execution of the compute kernels is performed by the computing device. For this reason, the monitoring apparatus instructs the computing device to execute the first and second compute kernels using the respective slices (and to provide the first and second compute kernel to the computing device), and to provide the information on the change of a status of at least one hardware counter associated with the first slice that is caused by the execution of the first compute kernel after the first compute kernel has been executed.

For the execution of the first and second compute kernels, the execution units of the computing device are partitioned into non-overlapping slices (i.e., the first slice and the one or more second slices are non-overlapping slices of the plurality of execution units), with the slices comprising at least the first slice and the one or more second slices. Each slice may comprise one or more execution units. In most cases, each slice may comprise a plurality of execution units. While terminology like “first slice” and “second slice(s)” are being used, there is not necessarily a mapping between the first slice and a slice 0 (e.g., a slice being supplied by a Compute Command Streamer (CCS) 0 of the computing device) of the computing device and the one or more second slice and a slice 1 (e.g., a slice being supplied by a CCS 1 of the computing device). In some examples, such a mapping may be used. In some other examples, a different mapping may be used. In other words, the first slice may be supplied by any of the CCS of the computing device if the computing device employs compute command streamers.

In general, the slices of execution units may be static or variable. In the static case, the slices may always include the same (or at least same number of) execution units. In other words, the first slice and/or the one or more second slices each comprise a fixed number of execution units. In the variable case, the execution units that are part of the respective slices, and/or the number of execution units that are part of the respective slices, may vary. In other words, the first slice and/or the one or more second slices may each comprise a variable (i.e., adjustable, or changeable) number of execution units. The number of execution units that are part of the respective slices may be set and/or adjusted by the control circuitry of the computing device, e.g., in response to the compute kernels being processed by the computing device or in response to a user setting. At least in the variable case, the processing circuitry may be configured to obtain information on execution units being part of the respective slices from the computing device, and to determine the information on the execution of the first compute kernel further based on the information on the execution units being part of the respective slices. Accordingly, as further shown in FIG. 1c, the monitoring method may comprise obtaining 150 information on execution units being part of the respective slices from the computing device and determining 160 the information on the execution of the first compute kernel further based on the information on the execution units being part of the respective slices.

The computing device then concurrently (i.e., at the same time, in parallel) executes the first compute kernel (being monitored) and the one or more second compute kernels. Contrary to other approaches, the concurrency may be enforced, to make sure the monitoring (and particular profiling) of the first compute kernel also takes into account the impact of other compute kernels being executed at the same time (to model a real-life scenario). In particular, the processing circuitry may be configured to provide instructions to the control circuitry of the computing device to execute the first compute kernel and the one or more second compute kernels in a non-serialized manner (i.e., such that the first compute kernel and the one or more second compute kernels are executed concurrently). Moreover, to avoid cross-contamination of the monitoring results, the computing device may be instructed to execute the respective compute kernels such, that the at least one hardware counter associated with the first slice is not influenced by the execution of the one or more second compute kernels, i.e., by events generated by the one or more second compute kernels. In other words, the processing circuitry may be configured to provide instructions to the control circuitry of the computing device to execute the first compute kernel and the one or more second compute kernels such, that the at least one hardware counter associated with the first slice is unaffected by the concurrent execution of the one or more second compute kernels.

In the proposed concept, the at least one hardware counter is used to monitor, and in particular to profile, the first compute kernel. In other words, the activities of the first compute kernel are logged using the at least one hardware counter. For example, each time the first compute kernel uses a pre-defined hardware functionality of the execution units of the first slice, the at least one hardware counter is increased. This can be done by configuring the execution units to increase the respective hardware counter in response to an event encountered at the execution unit, e.g., when the pre-defined hardware functionality of the execution unit is accessed by the first compute kernel. Thus, the monitoring apparatus may configure the event (or events) to be counted. For example, the processing circuitry may be configured to provide instructions to the control circuitry of the computing device to configure at least one event to be counted by the at least one hardware counter. Accordingly, as further shown in FIG. 1c, the monitoring method may comprise providing 130 instructions to the control circuitry of the computing device to configure at least one event to be counted by the at least one hardware counter. In general, the computing device may be configured to increase the at least one hardware counter when various types of events occur. For example, the at least one event may comprise at least one of a floating-point unit pipelining event, a systolic pipelining event, a math pipelining event, a data-type specific event, a floating-point data-type specific event, an integer data-type specific event, an instruction-specific event, an extended math instruction-specific event, a jump instruction-specific event and a send instruction-specific event. For example, in case different events are to be monitored, the first compute kernel may be executed repeatedly, with different events being configured for each execution of the first compute kernel. Alternatively, if multiple hardware counters are supported by the execution units, the different hardware counters may be used to count the occurrences of different events. In general, the hardware counters may be non-presettable and non-resettable, such that the status of the hardware counter (i.e., the current counter value) cannot be altered arbitrarily, which may distort the monitoring or profiling of the first compute kernel.

In some cases, each slice of execution units may have (exactly) one hardware counter that is to be used by all of the execution units of the slice. While such a configuration is suitable for use with the proposed concept, in many cases, the hardware counter(s) are not linked to the slices, but to the execution units themselves. For example, each execution unit (at least of the first slice) may comprise a separate hardware counter. As a consequence, the information on the change of the status of at least one hardware counter may comprise information on the change of the status of at least one hardware counter per execution unit of the first slice. In this case, the change of status may be treated separately for each execution unit (to allow for an execution unit-specific monitoring of the first compute kernel). Additionally, or alternatively, the change of status may be aggregated (e.g., summed up, averaged, a maximum or minimum determined) over the execution units of the first slice. In other words, the processing circuitry may be configured to aggregate the information on the change of the status of the at least one hardware counter per execution unit of the first slice, and to determine the information on the execution of the first compute kernel based on the aggregate. Accordingly, as further shown in FIG. 1c, the monitoring method may comprise aggregating 140 the information on the change of the status of the at least one hardware counter per execution unit of the first slice and determining 160 the information on the execution of the first compute kernel based on the aggregate.

In the present disclosure, the change of the status of the at least one hardware counter is used to determine the information on the execution of the first compute kernel. In this context, the status of the at least one hardware counter may refer to the current counter value of the hardware counter. Accordingly, the change of status may refer to the difference between two counter values taken at two different times. In general, the information on the change of the status of the at least one hardware counter may comprise the two counter values (e.g., per hardware counter) and/or the difference between the two counter values (e.g., per hardware counter or as an aggregate over multiple hardware counters).

The processing circuitry is configured to determine the information on the execution of the first compute kernel based on the information on the change of the status of the at least one hardware counter. For example, the information on the execution of the first compute kernel may comprise profiling information, based on the change of status of the at least one hardware kernel. For example, the information on the execution of the first compute kernel may comprise the aforementioned counter values or difference(s) between the counter values, which may be used to profile the execution of the first compute kernel. For example, as will become evident in the following these counter values, and differences between the counter values, may represent the hardware functionality being used by the first compute kernel, and may correspond to a numeric representation of how often a pre-defined hardware functionality of the execution units (or the computing device) has been used by the first compute kernel.

As outlined above, various types of events can be counted by the at least one hardware counter. These events may often relate to hardware functionality being used by the first compute kernel, e.g., as the hardware counter cannot be set or altered directly by the first compute kernel. For example, each time a pre-defined hardware functionality is being used, an event is triggered by the respective execution unit, which is then counted by the at least one hardware counter. As a result, the difference between the counter values may represent how often the pre-defined hardware functionality has been used, and thus triggered the event being counted. Consequently, the processing circuitry may be configured to determine the information on the execution of the first compute kernel with information on hardware functionality being used by the execution of the first compute kernel. Since the hardware functionality being used triggers the corresponding events, the information on the hardware functionality being used by the execution of the first compute kernel may comprise at least one of information on a use of a floating point unit pipeline, information on a use of a systolic pipeline, information on a use of a math pipeline, information on a use of a data-type specific functionality, and information on a use of one or more pre-defined instructions executed by the execution units of the first slice. In other words, the information on the hardware functionality being used by the execution of the first compute kernel may represent how often the hardware functionality was used (which led to the emission of the respective events). Again, if the use of different hardware functionality is to be monitored, different hardware counters may be used, or the first compute kernel may be executed multiple times (with changing event configuration).

In general, compute kernels behave differently depending on the number of execution units being used for execution of the compute kernel. For example, the more compute kernels are allocated for executing a compute kernel, the more computations can be performed in parallel. Moreover, in some cases, details like memory access latencies may vary, depending on which execution unit is used to access data from which portion of the memory. Therefore, it may be useful to include information on the execution units being part of the first slice in the information on the execution of the first compute kernel. In other words, the processing circuitry may be configured to include the information on the execution units being part of the first slice in the information on the execution of the first compute kernel.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general-purpose processor, a Digital Signal Processor (DSP), a micro-controller, etc.

For example, the storage circuitry 16 or means for storing information 16 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system 100 may be a workstation computer system (e.g., a workstation computer system being used for scientific computation) or a server computer system, i.e., a computer system being used to serve functionality, such as the computer program, to one or client computers.

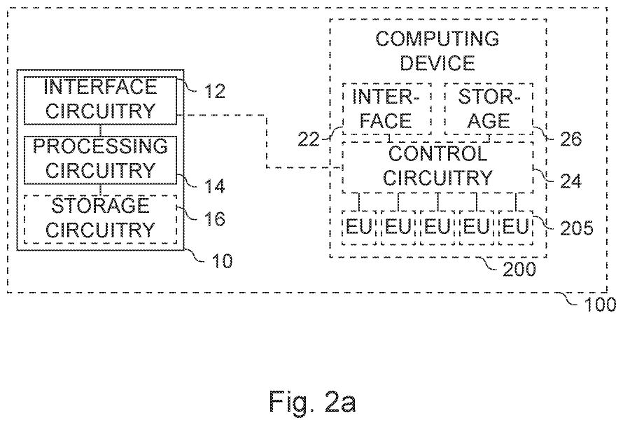

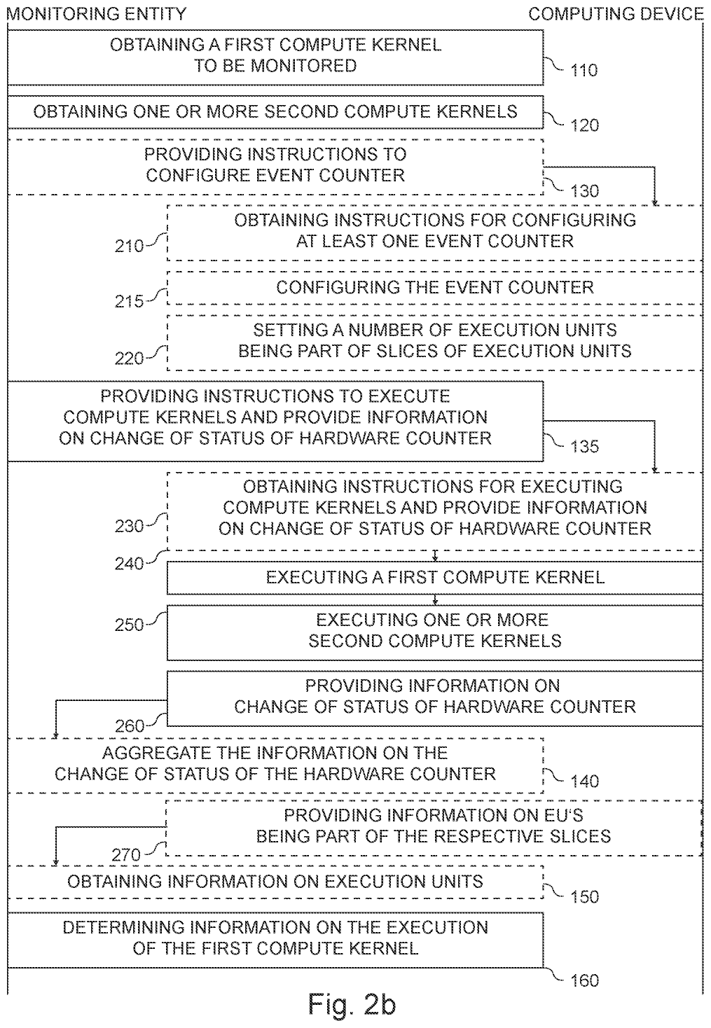

More details and aspects of the monitoring apparatus 10, monitoring device 10, monitoring method, computer program and (computer) system 100 are mentioned in connection with the proposed concept or one or more examples described above or below (e.g., FIGS. 2a to 5). The monitoring apparatus 10, monitoring device 10, monitoring method, computer program and (computer) system 100 may comprise one or more additional optional features corresponding to one or more aspects of the proposed concept, or one or more examples described above or below.

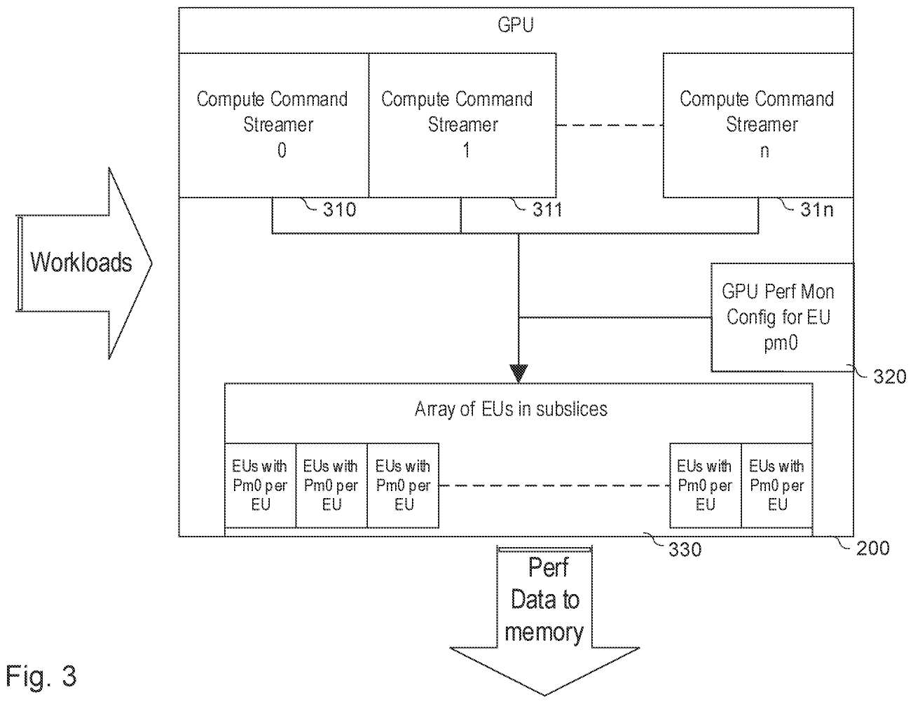

FIG. 2a shows a block diagram of an example of a computing device 200 (e.g., a Graphics Processing Unit) and of a (computer) system 100 comprising the computing device 200 and a monitoring apparatus 10 or monitoring device 10 (e.g., as shown in connection with FIGS. 1a to 1c). The computing device 200 comprises circuitry that is configured to provide the functionality of the computing device 200. For example, the monitoring computing device 200 of FIGS. 2a and 2b comprises (optional) interface circuitry 22, control circuitry 24, (optional) storage circuitry 26 and a plurality of execution units 205. For example, the control circuitry 24 may be coupled with the interface circuitry 22, with the storage circuitry 26 and with the plurality of execution units 205. For example, the control circuitry 24 may be configured to control the computing device, using the interface circuitry 22 (for exchanging information, e.g., with other components inside or outside a computer system 100, such as a monitoring apparatus 10 or monitoring device 10) and the storage circuitry (for storing information, such as machine-readable instructions) 26. The control circuitry 24 may be configured to control the execution units 205, e.g., by scheduling the execution of compute kernels by the plurality of execution units 205, and/or by assigning the plurality of execution units to slices of execution units. In some configurations, e.g., as shown in FIG. 3, the control circuitry 24 may be implemented by so-called compute command streamers (CCS). In general, the functionality of the control circuitry 24 may be implemented by the control circuitry 24 executing machine-readable instructions. Accordingly, any feature ascribed to the control circuitry 24 may be defined by one or more instructions of a plurality of machine-readable instructions. The computing device 200 may comprise the machine-readable instructions, e.g., within the storage circuitry 26.

The control circuitry 24 is configured, based on instructions of the monitoring apparatus, to execute a first compute kernel using a first slice of the plurality of execution units. The control circuitry 24 is configured, based on instructions of the monitoring apparatus, to execute one or more second compute kernels concurrently with the first compute kernel using one or more second slices of the plurality of execution units. The control circuitry 24 is configured, based on instructions of the monitoring apparatus, to provide information on a change of a status of at least one hardware counter associated with the first slice that is caused by the execution of the first compute kernel to the monitoring apparatus.

FIG. 2a further shows the system 100, which comprises both the computing device 200 and the monitoring apparatus 10 or monitoring device 10, e.g., as introduced in connection with FIGS. 1a to 1c.

FIG. 2b shows a flow chart of an example of a method, or rather two methods, which may be combined into one. On the left, FIG. 2b shows an example of the monitoring method already shown in connection with FIG. 1c, with the monitoring method being performed by a monitoring entity, such as the monitoring apparatus 10 or monitoring device. On the right, FIG. 2b shows an example of a computing method being by the computing device, and in particular by the control circuitry 24 of the computing device. The computing method comprises, based on instructions provided by the monitoring entity (e.g., as a result of the monitoring method), executing 240 the first compute kernel using the first slice of the plurality of execution units. The computing method comprises, based on instructions provided by the monitoring entity, executing 250 the one or more second compute kernels concurrently with the first compute kernel using the one or more second slices of the plurality of execution units. The computing method comprises, based on instructions provided by the monitoring entity, providing 260 the information on the change of a status of at least one hardware counter associated with the first slice that is caused by the execution of the first compute kernel to the monitoring apparatus. For example, the monitoring method and the computing method may be performed by a computer system 100 comprising a monitoring entity 10 and a computing device 200. Together, the monitoring method and computing method may form a common (system) method comprising at least some of the features of both methods.

In the following, the features of the computing device 200 of the computing method and of a corresponding computer program will be introduced in more detail with respect to the computing device 200. Features introduced in connection with the computing device 200 can likewise be included in the corresponding computing method and computer program

In the proposed concept, the computing device 200 shown in connection with FIGS. 2a and 2b is the counterpart of the monitoring apparatus 10 or monitoring device 10—it is used to execute the first and second compute kernels, as specified by the monitoring apparatus 10 or monitoring device 10 and provide the information on the change of the change of the status of at least one hardware counter to the monitoring apparatus 10 or monitoring device 10 for monitoring and profiling purposes. The computing device is under the control of the monitoring apparatus 10 or monitoring device 10 and is thus configured by the monitoring apparatus 10 or monitoring device 10.

One aspect of the computing device that may be configured by the monitoring apparatus 10 or monitoring device 10 relates to the events being logged by the at least one hardware counter. For example, as outlined in connection with FIGS. 1a to 1b, the monitoring apparatus 10 or monitoring device 10 may configure the computing device to increase the at least one hardware counter in case a pre-defined event occurs. As discussed above, the at least one event may relate to a hardware functionality of the computing device (e.g., of the execution units). For example, the control circuitry may be configured to obtain instructions for configuring at least one event to be counted by the at least one hardware counter from the monitoring apparatus, and to configure the at least one event to be counted by the at least one hardware counter based on the instructions. Accordingly, as shown in FIG. 2b, the monitoring method may comprise providing 130 instructions to the control circuitry of the computing device to configure at least one event to be counted by the at least one hardware counter and the computing method may comprise obtaining 210 the instructions for configuring at least one event to be counted by the at least one hardware counter, and configuring 215 the at least one event to be counted by the at least one hardware counter based on the instructions.

Apart from configuring the event to be counted, the control circuitry has two purposes—executing the compute kernels and generating and providing the information on the change of a status of at least one hardware counter. As outlined above, the control circuitry merely controls the functionality, while the actual computations (related to the compute kernels) are performed by the execution units. Accordingly, the control circuitry may be configured to schedule the execution of the compute kernels by the plurality of execution units 205, and/or assign the plurality of execution units to slices of execution units. For example, the control circuitry may be configured to obtain the compute kernels from the monitoring apparatus (which may thus provide the compute kernels) prior to execution, and then provide the compute kernels for execution to the respective slices of execution units.

In the proposed concept, the execution of the compute kernels is separated—the first compute kernel is executed using the first slice of execution units, while the other (i.e., the one or more second) compute kernels use the remaining slice(s) of execution units. This has the purpose of allowing a concurrent (i.e., non-serialized) execution of the first compute kernel and of the one or more second compute kernels, without the execution of the second compute kernels affecting the at least one hardware counter associated with the first slice of execution units. In other words, the control circuitry may be configured, based on instructions by the monitoring apparatus, to execute the first compute kernel and the one or more second compute kernels in a non-serialized manner. Moreover, the control circuitry may be configured, based on instructions by the monitoring apparatus, to execute the first compute kernel and the one or more second compute kernels such, that the at least one hardware counter associated with the first slice is unaffected by the concurrent execution of the one or more second compute kernels.

In the present disclosure, this is achieved by the use of separate slices of execution units, with hardware counters that are only affected within (and not between) slices. In other words, a hardware counter associated with a slice only counts events triggered by an execution unit of the same slice. The control circuitry is configured to read out the at least one hardware counter associated with the first slice before and after execution of the first compute kernel, and to determine the information on the change of the status of the at least one hardware counter based on the read-out counter values (before and after the execution of the first compute kernel). For example, the control circuitry may be configured to include the read-out counter values (per hardware counter) in the information on the change of the status of the at last one hardware counter (with the two counter values representing the change of the status of the at least one hardware counter). Additionally, or alternatively, the control circuitry may be configured to determine a difference between the counter values, and to include the difference (e.g., per hardware counter, or aggregated over the hardware counters associated with the first slice) in the information on the change of the status of the at last one hardware counter. As becomes evident, if the first slice is associated with multiple hardware counters (e.g., if the at least one hardware counter associated with the first slice comprises at least one hardware counter per execution unit of the first slice), the information on the status may comprise the information on the status separately per hardware counter of the first slice or aggregated over the hardware counters associated with the first slice. In consequence, the information on the change of the status of at least one hardware counter may comprise information on the change of the status of the at least one hardware counter per execution unit of the first slice.

As discussed in connection with FIGS. 1a to 1c, the slices may either each comprise a fixed number of execution units or they may each comprise a variable number of execution units. In the latter case, the control circuitry may be tasked with allocating (e.g., configured to allocate) the execution units to the slices, e.g., based on the compute kernels to be executed by the respective slices. In particular, the control circuitry may be configured to set the number of execution units being part of the respective slices, and to provide information on the execution units being part of the respective slices to the monitoring apparatus. Accordingly, the computing method may comprise setting 220 the number of execution units being part of the respective slices and providing 270 information on the execution units being part of the respective slices to the monitoring entity. The monitoring entity may then obtain (150) the information on execution units being part of the respective slices from the computing device and determine (160) the information on the execution of the first compute kernel further based on the information on the execution units being part of the respective slices.

The interface circuitry 22 or means for communicating 22 may correspond to one or more inputs and/or outputs for receiving and/or transmitting information, which may be in digital (bit) values according to a specified code, within a module, between modules or between modules of different entities. For example, the interface circuitry 22 or means for communicating 22 may comprise circuitry configured to receive and/or transmit information.

For example, the control circuitry 24 or means for control 24 may be implemented using one or more control units, one or more control devices, any means for control, such as a processor, a computer or a programmable hardware component being operable with accordingly adapted software. In other words, the described function of the control circuitry 24 or means for control may as well be implemented in software, which is then executed on one or more programmable hardware components. Such hardware components may comprise a general-purpose processor, a Digital Signal Processor (DSP), a micro-controller, etc.

For example, the storage circuitry 26 or means for storing information 26 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the computing device 200, the system 100, the computing method, the monitoring method, and the corresponding computer programs are mentioned in connection with the proposed concept, or one or more examples described above or below (e.g., FIG. 1a to 1c, 3 to 5). The computing device 200, the system 100, the computing method, the monitoring method, and the corresponding computer programs may comprise one or more additional optional features corresponding to one or more aspects of the proposed concept, or one or more examples described above or below.

Various examples of the present disclosure relate to an approach and method for precise monitoring of compute kernels, such as GPU (Graphics Processing Unit) kernels, in highly concurrent execution environments. The proposed concept uses a combination of hardware and software approaches to perform the precise measurement.

The proposed concept uses hardware GPU partitioning and hardware work scheduling, e.g., by using the functionality of Compute Command Streamers (CCS) integrated in Intel® GPUs. According to the proposed concept, each execution kernel to be profiled is assigned to one slice of execution units, e.g., by assigning the execution kernel to be profiled to one compute command streamer (CCS), while all other remaining kernels get assigned to other compute slices, e.g., to other command streamers. That enables or facilitates employing an event-configurable, always running, not pre- or resettable counter (e.g., a hardware counter) inside each slice or each Execution Unit (EU) of the computing device (e.g., GPU). All threads spawned by the kernel of interest to be profiled (i.e., the first compute kernel) read the configured hardware at runtime at the start and end of each thread. The hardware counter values are sent to memory, where software is used analyze the performance data for the kernel of interest for all threads of the kernel, as chosen for performance monitoring from its respective compute command streamer hardware context.

This method enables operators to precisely measure operational characteristic of a given compute kernel (e.g., GPU kernel), while executing in a multi-kernel and multiple EU hardware thread environment, without any workload serialization or other restrictive limitations that fundamentally alter the originally intended behavior of hardware and software, giving valuable tools for debugging, tuning, and observing the behavior of compute kernels. Such performance profiling might not be possible with other approaches or other hardware. The use of non-presettable and non-resettable per-EU or per slice of EUs hardware counters may provide robustness against data corruption and configuration override issues that are difficult to identify (and which are the issues fully programmable systems are prone to), and at the same time provide for simplicity of use. The proposed concept can be easily mapped to different types of hardware and software (via different means of computing device partitioning, not necessarily through the aforementioned compute command streamers). In various examples of the proposed concept, there might be no restrictions on profiling concurrent kernels and threads.

FIG. 3 shows a schematic diagram of an example of an overall GPU architecture of a GPU 200 comprising multiple compute command streamers 310-31n (e.g., the control circuitry), and an array of execution units (EUs) 330 (e.g., the plurality of execution units) in multiple sub-slices. GPU workloads executes on the array of EUs as dispatched through the command streamers 310-31n. In the example shown in FIG. 3, each EU has a performance counter (Pm0) to count an EU event configured through GPU performance monitoring hardware 320. It outputs performance (perf) data to memory.

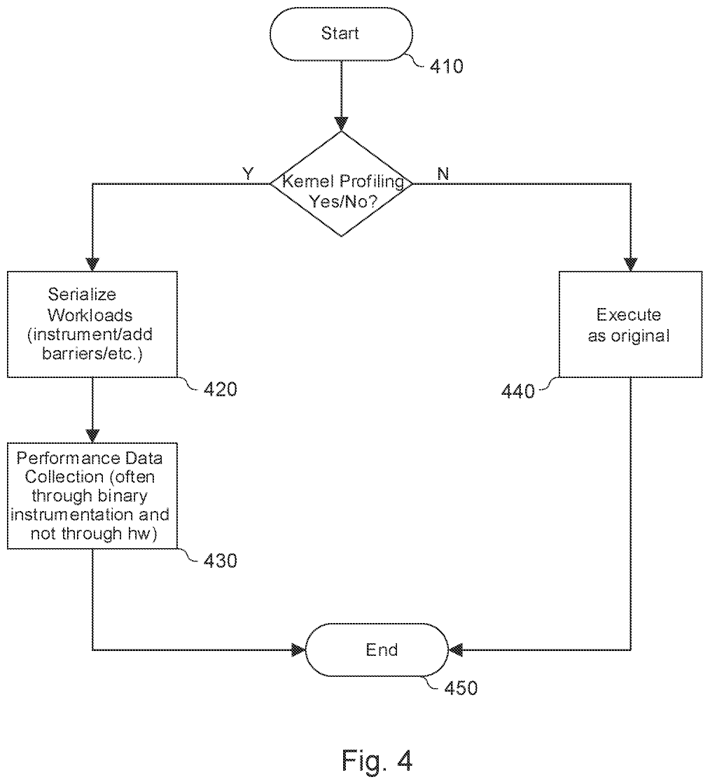

FIG. 4 shows a flow chart of an example of a kernel profiling approach without using the proposed concept, i.e., a method where all the workloads and kernels are serialized. At 410, the kernel profiling flow starts. Performance data is collected on the serialized kernel of interest afterwards. Often this serialization involves instrumentation of the code, adding barriers and other techniques to modify the binary or the workload itself. Performance data collection for this approach may involve binary instrumentation for counting instructions/operations/etc. using software counters for kernel profiling. Thus, if kernel profiling is to be performed, the flow includes serializing 420 the workloads (including instrumentation, adding barriers etc.), and collecting 430 the performance data (often through binary instrumentation and not through hardware (hw)), before reaching the end 450 of the flow. If no kernel profiling is to be performed, the compute kernels are executed 440 without modification (e.g., as originally intended), then proceeding to the end of the flow.

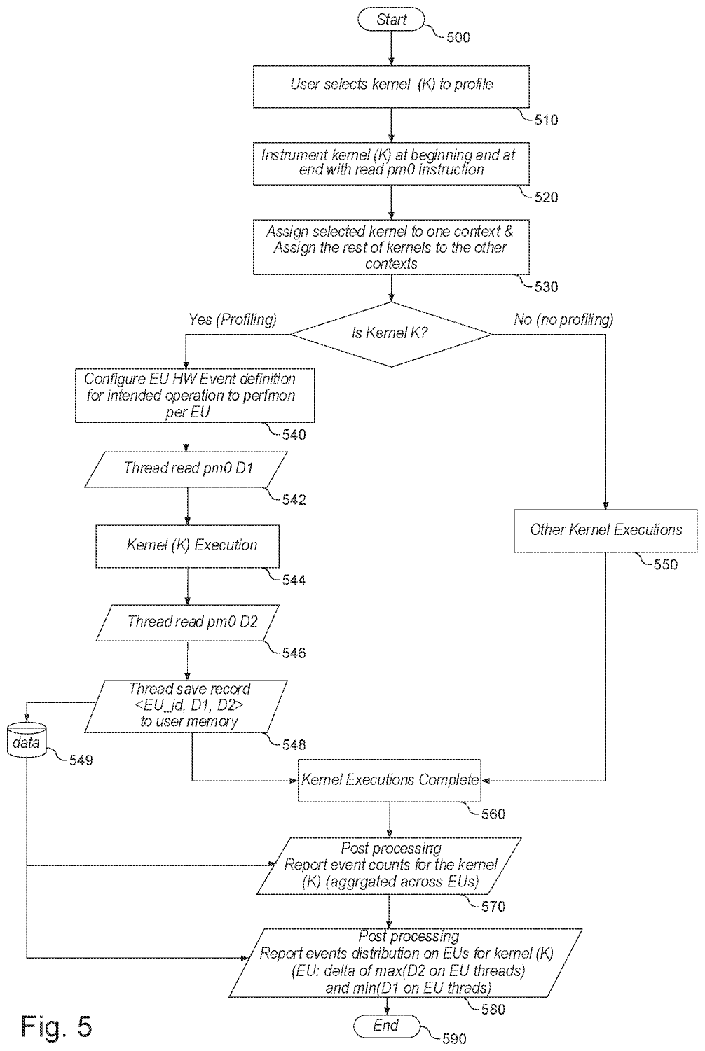

FIG. 5 shows a flow chart of an example of the proposed concept. The flow starts at 500. First, the user selects 510 a kernel (K) to profile. At 520, the selected kernel is instrumented at the beginning and end with an instruction to read the pm0 hardware counter, along with sending the counter value to user memory. This instrumentation can be done through binary or kernel intrinsic or other avenues. At 530, the selected kernel is assigned to one context and the rest of the kernels are assigned to the other contexts. The kernel to be profiled is thus sent to an individual compute command streamer (e.g., CCS0) while all other kernels a resent to remaining compute command streamers (e.g., CCS1/2/3). In case of kernel profiling usage (i.e., for kernel K), at 540 a hardware counter is configured for a desired EU event definition (e.g., FPU pipeline, systolic pipeline activity, or per data type instruction fp32/int64/extended math/jump/send/etc.), e.g., through A7 event configuration for an Intel® CPU, to perform performance monitoring (perfmon) per EU. This hardware counter is per EU, always running and not preset-or-resettable.

At 542 and 546, each thread of the kernel reads the pm0 at the beginning and at the end of kernel execution 544, while other kernels also execute 550 in parallel in other hardware contexts. At 548, the pm0 and EU IDs are saved to user memory (data 549) as the kernel executions complete 560. At 570, the saved data is post processed by software to report event counts (which may represent hardware cost) for the profiled kernel by aggregating across all dynamically hardware-allocated EUs. At 580, event distributions across EUs may also be calculated for the profiled kernel to identify per EU cost, balancing and other parameters, issues, and optimization. At 590, the flow ends.

As there is no resetting or presetting involved on pm0 and neither any per-EU configuration or any restrictive binding, the proposed approach is robust against any accidental clearing/loading/other data contentions and configuration overrides.

Without the proposed concept, it may not be possible to simply read a counter at the beginning and at the end of a kernel in a concurrent GPU environment (in other words, in any efficient modern multi-kernel environment), because the counter value may include events for an arbitrary number of instances of simultaneously running kernels, and there are, in general, no means to differentiate between which kernel contributed to the total count and by how much. Alternatively, the execution of all kernels may be serialized to precisely measure just one kernel of interest—but that may distort the behavior and performance of the entire GPU and render the measurements useless.

In the proposed concept, the kernel of interest runs on a separate GPU partition. It may minimally affect the behavior and performance of the rest of the kernels, as they are still running concurrently on other partitions. The unique use of hardware partitioning and scheduling enables employing a simple counter-reading instruction at the beginning and at the end of a GPU kernel. For example, Intel®'s Compute Command Streamer concept fits the requirements of the proposed concept (as it provides both partitioning and per-EU hardware counters).

While counters, FIFOs (First In, First Out elements), registers are generic across the digital designs for many decades, the proposed concept makes a simple and straightforward technique for reading a counter applicable to monitoring GPU kernels. In many cases, when multiple kernels are executed concurrently and, on top of that, spawn parallel threads, it becomes impossible to simply read a hardware counter, because that counter may count events from other concurrent kernels, as well. To avoid such distortions, partitioning, which may be provided by the aforementioned Compute Command Streamers, can be used to isolate work and measurements on a particular context (or partition). In effect, the kernel being measured is running on one partition, and the rest of kernels—on the rest of partitions. This may enable the simple reading of a non-resettable counter at the beginning and at the end of the kernel being monitored, without the counter being polluted with events from other kernels. While the proposed concept has been illustrated with respect to Intel® hardware, other computing device, such as GPUs, also offer partitioning concepts, which may be used to achieve the same effect on other hardware too.

In the following, some examples of the proposed concept are given.

An example (e.g., example 1) relates to a monitoring apparatus (10), the monitoring apparatus comprising interface circuitry (12) and processing circuitry (14), the processing circuitry being configured to obtain a first compute kernel to be monitored. The processing circuitry is configured to obtain one or more second compute kernels. The processing circuitry is configured to provide instructions, using the interface circuitry, to control circuitry (24) of a computing device (200) comprising a plurality of execution units (205), to instruct the control circuitry to execute the first compute kernel using a first slice of the plurality of execution units and to execute the one or more second compute kernels concurrently with the first compute kernel using one or more second slices of the plurality of execution units, and to instruct the control circuitry to provide information on a change of a status of at least one hardware counter associated with the first slice that is caused by the execution of the first compute kernel. The processing circuitry is configured to determine information on the execution of the first compute kernel based on the information on the change of the status of the at least one hardware counter.

Another example (e.g., example 2) relates to a previously described example (e.g., example 1) or to any of the examples described herein, further comprising that the information on the change of the status of at least one hardware counter comprises information on the change of the status of at least one hardware counter per execution unit of the first slice.

Another example (e.g., example 3) relates to a previously described example (e.g., example 2) or to any of the examples described herein, further comprising that the processing circuitry is configured to aggregate the information on the change of the status of the at least one hardware counter per execution unit of the first slice, and to determine the information on the execution of the first compute kernel based on the aggregate.

Another example (e.g., example 4) relates to a previously described example (e.g., one of the examples 1 to 3) or to any of the examples described herein, further comprising that the processing circuitry is configured to provide instructions to the control circuitry of the computing device to configure at least one event to be counted by the at least one hardware counter.

Another example (e.g., example 5) relates to a previously described example (e.g., example 4) or to any of the examples described herein, further comprising that the at least one event comprises at least one of a floating-point unit pipelining event, a systolic pipelining event, a math pipelining event, a data-type specific event, a floating-point data-type specific event, an integer data-type specific event, an instruction-specific event, an extended math instruction-specific event, a jump instruction-specific event and a send instruction-specific event.

Another example (e.g., example 6) relates to a previously described example (e.g., one of the examples 1 to 5) or to any of the examples described herein, further comprising that the processing circuitry is configured to determine the information on the execution of the first compute kernel with information on hardware functionality being used by the execution of the first compute kernel.

Another example (e.g., example 7) relates to a previously described example (e.g., example 6) or to any of the examples described herein, further comprising that the information on the hardware functionality being used by the execution of the first compute kernel comprises at least one of information on a use of a floating point unit pipeline, information on a use of a systolic pipeline, information on a use of a math pipeline, information on a use of a data-type specific functionality, and information on a use of one or more pre-defined instructions executed by the execution units of the first slice.

Another example (e.g., example 8) relates to a previously described example (e.g., one of the examples 1 to 7) or to any of the examples described herein, further comprising that the processing circuitry is configured to provide instructions to the control circuitry of the computing device to execute the first compute kernel and the one or more second compute kernels such, that the at least one hardware counter associated with the first slice is unaffected by the concurrent execution of the one or more second compute kernels.

Another example (e.g., example 9) relates to a previously described example (e.g., one of the examples 1 to 8) or to any of the examples described herein, further comprising that the processing circuitry is configured to provide instructions to the control circuitry of the computing device to execute the first compute kernel and the one or more second compute kernels in a non-serialized manner.

Another example (e.g., example 10) relates to a previously described example (e.g., one of the examples 1 to 9) or to any of the examples described herein, further comprising that the processing circuitry is configured to obtain information on execution units being part of the respective slices from the computing device, and to determine the information on the execution of the first compute kernel further based on the information on the execution units being part of the respective slices.

Another example (e.g., example 11) relates to a previously described example (e.g., one of the examples 1 to 10) or to any of the examples described herein, further comprising that the one or more second compute kernels belong to the same computer program or to different computer programs.

Another example (e.g., example 12) relates to a previously described example (e.g., one of the examples 1 to 11) or to any of the examples described herein, further comprising that the first compute kernel and/or the one or more second compute kernels are related to one or more of compute operations, render operations and media operations.

An example (e.g., example 13) relates to a system (100) comprising the monitoring apparatus (10) according to one of the examples 1 to 12 (or according to any other example). The system (100) comprises a computing device (200) comprising control circuitry (24) and a plurality of execution units (205), the control circuitry being configured, based on instructions of the monitoring apparatus, to execute a first compute kernel using a first slice of the plurality of execution units, execute one or more second compute kernels concurrently with the first compute kernel using one or more second slices of the plurality of execution units, and provide information on a change of a status of at least one hardware counter associated with the first slice that is caused by the execution of the first compute kernel to the monitoring apparatus.

Another example (e.g., example 14) relates to a previously described example (e.g., example 13) or to any of the examples described herein, further comprising that the control circuitry is configured to obtain instructions for configuring at least one event to be counted by the at least one hardware counter from the monitoring apparatus, and to configure the at least one event to be counted by the at least one hardware counter based on the instructions.

Another example (e.g., example 15) relates to a previously described example (e.g., one of the examples 13 to 14) or to any of the examples described herein, further comprising that the at least one hardware counter associated with the first slice comprises at least one hardware counter per execution unit of the first slice.

Another example (e.g., example 16) relates to a previously described example (e.g., example 15) or to any of the examples described herein, further comprising that the information on the change of the status of at least one hardware counter comprises information on the change of the status of the at least one hardware counter per execution unit of the first slice.

Another example (e.g., example 17) relates to a previously described example (e.g., one of the examples 13 to 16) or to any of the examples described herein, further comprising that the first slice and the one or more second slices are non-overlapping slices of the plurality of execution units.

Another example (e.g., example 18) relates to a previously described example (e.g., one of the examples 13 to 17) or to any of the examples described herein, further comprising that each slice of the plurality of execution units comprises one or more execution units.

Another example (e.g., example 19) relates to a previously described example (e.g., one of the examples 13 to 18) or to any of the examples described herein, further comprising that the first slice and/or the one or more second slices each comprise a fixed number of execution units.

Another example (e.g., example 20) relates to a previously described example (e.g., one of the examples 13 to 18) or to any of the examples described herein, further comprising that the first slice and/or the one or more second slices each comprise a variable number of execution units, with the control circuitry being configured to set the number of execution units being part of the respective slices, and to provide information on the execution units being part of the respective slices to the monitoring apparatus.

Another example (e.g., example 21) relates to a previously described example (e.g., one of the examples 13 to 20) or to any of the examples described herein, further comprising that the control circuitry is configured, based on instructions by the monitoring apparatus, to execute the first compute kernel and the one or more second compute kernels such, that the at least one hardware counter associated with the first slice is unaffected by the concurrent execution of the one or more second compute kernels.

Another example (e.g., example 22) relates to a previously described example (e.g., one of the examples 13 to 21) or to any of the examples described herein, further comprising that the control circuitry is configured, based on instructions by the monitoring apparatus, to execute the first compute kernel and the one or more second compute kernels in a non-serialized manner.

Another example (e.g., example 23) relates to a previously described example (e.g., one of the examples 13 to 22) or to any of the examples described herein, further comprising that the computing device is a graphics processing unit.

Another example (e.g., example 24) relates to a previously described example (e.g., one of the examples 13 to 23) or to any of the examples described herein, further comprising that the system is a computer system.

An example (e.g., example 25) relates to a monitoring apparatus (10), the monitoring apparatus comprising interface circuitry (12), machine-readable instructions and processing circuitry (14) to execute the machine-readable instructions to obtain a first compute kernel to be monitored. The machine-readable instructions comprise instructions to obtain one or more second compute kernels. The machine-readable instructions comprise instructions to provide instructions, using the interface circuitry, to control circuitry (24) of a computing device (200) comprising a plurality of execution units (205), to instruct the control circuitry to execute the first compute kernel using a first slice of the plurality of execution units and to execute the one or more second compute kernels concurrently with the first compute kernel using one or more second slices of the plurality of execution units, and to instruct the control circuitry to provide information on a change of a status of at least one hardware counter associated with the first slice that is caused by the execution of the first compute kernel. The machine-readable instructions comprise instructions to determine information on the execution of the first compute kernel based on the information on the change of the status of the at least one hardware counter.

An example (e.g., example 26) relates to a system (100) comprising the monitoring apparatus (10) according to example 25 (or according to any other example). The system (100) comprises a computing device (200) comprising a plurality of execution units (205), machine-readable instructions and control circuitry to execute the machine-readable instructions to, based on instructions of the monitoring apparatus execute a first compute kernel using a first slice of the plurality of execution units, execute one or more second compute kernels concurrently with the first compute kernel using one or more second slices of the plurality of execution units, and provide information on a change of a status of at least one hardware counter associated with the first slice that is caused by the execution of the first compute kernel to the monitoring apparatus.

An example (e.g., example 27) relates to a monitoring device (10), the monitoring device comprising means for communicating (12) and means for processing (14), the means for processing being configured to obtain a first compute kernel to be monitored. The means for processing is configured to obtain one or more second compute kernels. The means for processing is configured to provide instructions, using the means for communicating, to means for controlling (24) of a computing device (200) comprising a plurality of execution units (205), to instruct the means for controlling to execute the first compute kernel using a first slice of the plurality of execution units and to execute the one or more second compute kernels concurrently with the first compute kernel using one or more second slices of the plurality of execution units, and to instruct the means for controlling to provide information on a change of a status of at least one hardware counter associated with the first slice that is caused by the execution of the first compute kernel. The means for processing is configured to determine information on the execution of the first compute kernel based on the information on the change of the status of the at least one hardware counter.

An example (e.g., example 28) relates to a system (100) comprising the monitoring device (10) according to example 27 (or according to any other example) and a computing device (200) comprising means for controlling (24) and a plurality of execution units (205), the means for controlling being configured, based on instructions of the monitoring device, to execute a first compute kernel using a first slice of the plurality of execution units, execute one or more second compute kernels concurrently with the first compute kernel using one or more second slices of the plurality of execution units, and provide information on a change of a status of at least one hardware counter associated with the first slice that is caused by the execution of the first compute kernel to the monitoring device.

An example (e.g., example 29) relates to a monitoring method comprising obtaining (110) a first compute kernel to be monitored. The monitoring method comprises obtaining (120) one or more second compute kernels. The monitoring method comprises providing (135) instructions, to control circuitry of a computing device comprising a plurality of execution units, to instruct the control circuitry to execute the first compute kernel using a first slice of the plurality of execution units and to execute the one or more second compute kernels concurrently with the first compute kernel using one or more second slices of the plurality of execution units, and to instruct the control circuitry to provide information on a change of a status of at least one hardware counter associated with the first slice that is caused by the execution of the first compute kernel. The monitoring method comprises determining (160) information on the execution of the first compute kernel based on the information on the change of the status of the at least one hardware counter.

Another example (e.g., example 30) relates to a previously described example (e.g., example 29) or to any of the examples described herein, further comprising that the information on the change of the status of at least one hardware counter comprises information on the change of the status of at least one hardware counter per execution unit of the first slice, the monitoring method comprising aggregating (140) the information on the change of the status of the at least one hardware counter per execution unit of the first slice, and determining (160) the information on the execution of the first compute kernel based on the aggregate.

Another example (e.g., example 31) relates to a previously described example (e.g., one of the examples 29 to 30) or to any of the examples described herein, further comprising that the monitoring method comprises providing (130) instructions to the control circuitry of the computing device to configure at least one event to be counted by the at least one hardware counter.

Another example (e.g., example 32) relates to a previously described example (e.g., one of the examples 29 to 31) or to any of the examples described herein, further comprising that the monitoring method comprises determining the information on the execution of the first compute kernel with information on hardware functionality being used by the execution of the first compute kernel.

Another example (e.g., example 33) relates to a previously described example (e.g., one of the examples 29 to 32) or to any of the examples described herein, further comprising that the monitoring method comprises providing (135) instructions to the control circuitry of the computing device to execute the first compute kernel and the one or more second compute kernels such, that the at least one hardware counter associated with the first slice is unaffected by the concurrent execution of the one or more second compute kernels.

Another example (e.g., example 34) relates to a previously described example (e.g., one of the examples 29 to 33) or to any of the examples described herein, further comprising that the monitoring method comprises providing (135) instructions to the control circuitry of the computing device to execute the first compute kernel and the one or more second compute kernels in a non-serialized manner.

Another example (e.g., example 35) relates to a previously described example (e.g., one of the examples 29 to 34) or to any of the examples described herein, further comprising that the monitoring method comprises obtaining (150) information on execution units being part of the respective slices from the computing device and determining (160) the information on the execution of the first compute kernel further based on the information on the execution units being part of the respective slices.

An example (e.g., example 36) relates to a system method comprising the monitoring method according to one of the examples 29 to 35, the monitoring method being performed by a monitoring entity. The system method comprises a computing method being performed by control circuitry of a computing device comprising a plurality of execution units, the method comprising, based on instructions provided as part of the monitoring method executing (240) a first compute kernel using a first slice of the plurality of execution units. The system method comprises executing (250) one or more second compute kernels concurrently with the first compute kernel using one or more second slices of the plurality of execution units. The system method comprises providing (260) information on a change of a status of at least one hardware counter associated with the first slice that is caused by the execution of the first compute kernel to the monitoring apparatus.

Another example (e.g., example 37) relates to a previously described example (e.g., example 36) or to any of the examples described herein, further comprising that the monitoring method comprises providing (130) instructions to the control circuitry of the computing device to configure at least one event to be counted by the at least one hardware counter and the computing method comprises obtaining (210) the instructions for configuring at least one event to be counted by the at least one hardware counter, and configuring (215) the at least one event to be counted by the at least one hardware counter based on the instructions.

Another example (e.g., example 38) relates to a previously described example (e.g., one of the examples 36 to 37) or to any of the examples described herein, further comprising that the first slice and/or the one or more second slices each comprise a variable number of execution units, with the computing method comprising setting (220) the number of execution units being part of the respective slices, and providing (270) information on the execution units being part of the respective slices to the monitoring entity, the monitoring method comprising obtaining (150) information on execution units being part of the respective slices from the computing device, and determining (160) the information on the execution of the first compute kernel further based on the information on the execution units being part of the respective slices.

Another example (e.g., example 39) relates to a previously described example (e.g., one of the examples 36 to 38) or to any of the examples described herein, further comprising that the computing method comprises, based on instructions by the monitoring entity, executing the first compute kernel and the one or more second compute kernels such, that the at least one hardware counter associated with the first slice is unaffected by the concurrent execution of the one or more second compute kernels.

Another example (e.g., example 40) relates to a previously described example (e.g., one of the examples 36 to 39) or to any of the examples described herein, further comprising that the computing method comprises, based on instructions by the monitoring entity, executing the first compute kernel and the one or more second compute kernels in a non-serialized manner.

Another example (e.g., example 41) relates to a previously described example (e.g., one of the examples 36 to 40) or to any of the examples described herein, further comprising that the monitoring method and the computing method are performed by a computer system (100) comprising a monitoring entity (10) and a computing device (200).

An example (e.g., example 42) relates to a non-transitory machine-readable storage medium including program code, when executed, to cause a machine to perform the method of one of the examples 29 to 35 (or according to any other example) and/or the method of one of the examples 36 to 40 (or according to any other example).

An example (e.g., example 43) relates to a computer program having a program code for performing the method of one of the examples the method of one of the examples 29 to 35 (or according to any other example) and/or the method of one of the examples 36 to 40 (or according to any other example) when the computer program is executed on a computer, a processor, or a programmable hardware component.

An example (e.g., example 44) relates to a machine-readable storage including machine readable instructions, when executed, to implement a method or realize an apparatus as exampled in any pending claim or any example shown herein.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A monitoring apparatus, the monitoring apparatus comprising interface circuitry, machine-readable instructions, and processing circuitry to execute the machine-readable instructions to:
obtain a first compute kernel to be monitored;
obtain one or more second compute kernels;
provide instructions, using the interface circuitry, to control circuitry of a computing device comprising a plurality of execution units, to instruct the control circuitry to execute the first compute kernel using a first slice of the plurality of execution units and to execute the one or more second compute kernels concurrently with the first compute kernel using one or more second slices of the plurality of execution units, and to instruct the control circuitry to provide information on a change of a status of at least one hardware counter associated with the first slice that is caused by the execution of the first compute kernel; and
determine information on the execution of the first compute kernel based on the information on the change of the status of the at least one hardware counter.

2. The monitoring apparatus according to claim 1, wherein the information on the change of the status of at least one hardware counter comprises information on the change of the status of at least one hardware counter per execution unit of the first slice.

3. The monitoring apparatus according to claim 2, wherein the machine-readable instructions comprise instructions to aggregate the information on the change of the status of the at least one hardware counter per execution unit of the first slice, and to determine the information on the execution of the first compute kernel based on the aggregate.

4. The monitoring apparatus according to claim 1, wherein the machine-readable instructions comprise instructions to provide instructions to the control circuitry of the computing device to configure at least one event to be counted by the at least one hardware counter.

5. The monitoring apparatus according to claim 4, wherein the at least one event comprises at least one of a floating-point unit pipelining event, a systolic pipelining event, a math pipelining event, a data-type specific event, a floating-point data-type specific event, an integer data-type specific event, an instruction-specific event, an extended math instruction-specific event, a jump instruction-specific event and a send instruction-specific event.

6. The monitoring apparatus according to claim 1, wherein the machine-readable instructions comprise instructions to determine the information on the execution of the first compute kernel with information on hardware functionality being used by the execution of the first compute kernel.

7. The monitoring apparatus according to claim 6, wherein the information on the hardware functionality being used by the execution of the first compute kernel comprises at least one of information on a use of a floating point unit pipeline, information on a use of a systolic pipeline, information on a use of a math pipeline, information on a use of a data-type specific functionality, and information on a use of one or more predefined instructions executed by the execution units of the first slice.

8. The monitoring apparatus according to claim 1, wherein the machine-readable instructions comprise instructions to provide instructions to the control circuitry of the computing device to execute the first compute kernel and the one or more second compute kernels such, that the at least one hardware counter associated with the first slice is unaffected by the concurrent execution of the one or more second compute kernels.

9. The monitoring apparatus according to claim 1, wherein the machine-readable instructions comprise instructions to provide instructions to the control circuitry of the computing device to execute the first compute kernel and the one or more second compute kernels in a non-serialized manner.

10. The monitoring apparatus according to claim 1, wherein the machine-readable instructions comprise instructions to obtain information on execution units being part of the respective slices from the computing device, and to determine the information on the execution of the first compute kernel further based on the information on the execution units being part of the respective slices.

11. The monitoring apparatus according to claim 1, wherein the one or more second compute kernels belong to the same computer program or to different computer programs.

12. The monitoring apparatus according to claim 1, wherein the first compute kernel and/or the one or more second compute kernels are related to one or more of compute operations, render operations and media operations.

13. A system comprising:
the monitoring apparatus according to claim 1; and
a computing device comprising a plurality of execution units, machine-readable instructions and control circuitry to execute the machine-readable instructions to, based on instructions of the monitoring apparatus:
execute a first compute kernel using a first slice of the plurality of execution units, execute one or more second compute kernels concurrently with the first compute kernel using one or more second slices of the plurality of execution units, and
provide information on a change of a status of at least one hardware counter associated with the first slice that is caused by the execution of the first compute kernel to the monitoring apparatus.

14. The system according to claim 13, wherein the machine-readable constructions for the control circuitry comprise instructions to obtain instructions for configuring at least one event to be counted by the at least one hardware counter from the monitoring apparatus, and to configure the at least one event to be counted by the at least one hardware counter based on the instructions.

15. The system according to claim 13, wherein the at least one hardware counter associated with the first slice comprises at least one hardware counter per execution unit of the first slice.

16. The system according to claim 15, wherein the information on the change of the status of at least one hardware counter comprises information on the change of the status of the at least one hardware counter per execution unit of the first slice.

17. The system according to claim 13, wherein the first slice and the one or more second slices are non-overlapping slices of the plurality of execution units.

18. The system according to claim 13, wherein the first slice and/or the one or more second slices each comprise a fixed number of execution units.

19. The system according to claim 13, wherein the first slice and/or the one or more second slices each comprise a variable number of execution units, with the machine-readable constructions for the control circuitry comprising instructions to set the number of execution units being part of the respective slices, and to provide information on the execution units being part of the respective slices to the monitoring apparatus.

20. The system according to claim 13, wherein the machine-readable constructions for the control circuitry comprise instructions to, based on instructions by the monitoring apparatus, execute the first compute kernel and the one or more second compute kernels such, that the at least one hardware counter associated with the first slice is unaffected by the concurrent execution of the one or more second compute kernels.

21. The system according to claim 13, wherein the machine-readable constructions for the control circuitry comprise instructions to, based on instructions by the monitoring apparatus, execute the first compute kernel and the one or more second compute kernels in a non-serialized manner.

22. The system according to claim 13, wherein the computing device is a graphics processing unit.

23. A monitoring method comprising:
obtaining a first compute kernel to be monitored;
obtaining one or more second compute kernels;
providing instructions, to control circuitry of a computing device comprising a plurality of execution units, to instruct the control circuitry to execute the first compute kernel using a first slice of the plurality of execution units and to execute the one or more second compute kernels concurrently with the first compute kernel using one or more second slices of the plurality of execution units, and to instruct the control circuitry to provide information on a change of a status of at least one hardware counter associated with the first slice that is caused by the execution of the first compute kernel; and
determining information on the execution of the first compute kernel based on the information on the change of the status of the at least one hardware counter.

24. A non-transitory machine-readable storage medium including program code, when executed, to cause a machine to perform the method of claim 23.
